(19) United States
(12) Patent Application Publication
(10) Pub. No.: US 2025/0377370 A1
(43) Pub. Date: Dec. 11, 2025

(54) SAMPLE INTRODUCTION DEVICE AND SAMPLE INTRODUCTION METHOD

(71) Applicant: ELTRA GMBH, Haan (DE)

(72) Inventor: Serdar ISIK, Essen (DE)

(21) Appl. No.: 18/868,508

(22) PCT Filed: May 23, 2023
(86) PCT No.: PCT/EP2023/063833

§ 371 Date: Nov. 22, 2024

(30) Foreign Application Priority Data
May 24, 2022 (DE) 10 2022 113 161.0

(51) Int. Cl. G01N 35/04; G01N 35/10

(52) U.S. Cl. CPC G01N 35/04; G01N 35/1011; G01N 2035/0406; G01N 2035/0441

(57) ABSTRACT

The invention relates to a sample supply device and a sample supply method for supplying, in particular, crucible-shaped sample containers to an analyzer. According to the invention, it is provided that the sample containers are aligned in a defined manner with regard to a reproducibly correct output.

The invention relates to a sample feeding device according to the general concept of claim 1. In addition, the invention further relates to a sample feeding method according to the general concept of claim 10.

In modern material analysis, samples to be analyzed are usually subjected to a compositional analysis using various analyzers. A wide variety of analyzers are available for this purpose, of which several different variants are often provided in a laboratory environment. Analyses can be carried out quickly, cost-effectively and reproducibly in this way. High throughput rates and the lowest possible time and cost expenditure are desirable in order to work economically, especially in commercial laboratories. For this reason, the highest possible degree of automation in connection with the performance of material analyses is becoming increasingly important. In addition to carrying out the actual analysis, this also applies in particular to the area of sample handling, i.e. the preparation of samples, internal laboratory logistics and the feeding of individual samples to the corresponding analyzers.

Various approaches are known from the state of the art as to how samples can be prepared for analyses as quickly as possible and how they can be handled easily by operators. One of the aims here is to avoid errors, which can frequently occur with a high proportion of manual activities in everyday laboratory work and in particular with a high workload to achieve high throughput rates. Known solutions include, for example, conveyor lines or carousel arrangements by means of which samples in sample containers, especially in crucibles, are sequentially fed to an analyzer via a corresponding interface. Here, however, the labor-intensive step of loading the carrier system, i.e. the conveyor belt or the sample container carousel, by employees is often required before the system can achieve a time advantage through the automatic conveying and provision of sample containers.

However, trays or the like with a large number of sample containers can be prepared independently in advance of the actual analysis, so that preparation does not have to take place immediately before or during the analysis work. Corresponding conveyor systems can then be fed by such trays with sample containers, for example. Particularly when sample containers are provided without samples in them—i.e. in cases where the sample is only filled into the sample container on or in the analyzer shortly before the actual analysis—incorrectly oriented sample containers, for example upside down, can cause considerable disruption to the process. In some cases, sample containers are therefore checked before they are finally fed to the analyzer, for example using optical methods, a camera, light barrier or similar, and if a misorientation is detected, the process is stopped and the operator is notified by an error message. As this can lead to comparatively long delays in the process and thus to correspondingly high downtime costs, it is essential that the corresponding container trays or the like are loaded with the necessary care beforehand.

Another alternative is an arrangement in which a motorized gripper arm automatically moves back and forth between a sample container supply, for example a tray or a conveyor chain, and the analyzer in order to pick up individual sample containers and feed them to the analyzer. This method has the additional advantage that more complex handling of the samples or sample containers is also possible by means of such a gripper arm, for example if different types of sample containers require different handling or precise alignment is necessary depending on the interface of the analyzer. Provided an appropriate detection device is used, such a robotic arm also allows the correction of incorrect orientation of the sample containers, for example if they are inserted incorrectly or have fallen over on the tray. However, a significant disadvantage here is the susceptibility of the sometimes very complex mechanics, which may include a large number of interlocking or functionally coupled moving parts. The more complicated the structural design of such a robotized solution is, the higher the associated acquisition costs usually are. Malfunctions or defects are also associated with correspondingly high repair or replacement part costs.

Against this background, it is the task of the present invention to overcome the disadvantages of the prior art and to provide a way of feeding sample containers to an analyzer in a fast and reliable manner, whereby, on the one hand, the effort for the operating personnel in connection with the handling of the sample containers and the probability of errors occurring should be minimized in each case.

The aforementioned task is solved according to the invention by a sample supply device with the features of claim 1. In the sample supply device according to the invention, sample containers are dispensed by a corresponding dispensing device, from which individual sample containers are supplied either directly or indirectly, i.e. after appropriate further transport, for analysis in the analyzer. The dispensing device can, for example, be formed by or have a dispensing opening or a dispensing channel. According to the invention, this dispensing device is preceded by an alignment device by means of which the sample containers can be aligned in a defined manner. In this case, the target is usually defined as an alignment that is suitable for transferring the sample container to the analyzer and thus for trouble-free further processing of the sample container. It is understood that this can vary depending on the analyzer.

Particularly in the case of crucible-shaped sample containers, which have the basic shape of a hollow cylinder or cuboid open at one end, the correct orientation is often defined in such a way that the opening is directed upwards so that a sample can be filled into the sample receiving space inside following the force of gravity. In this case, sample containers are often dispensed downwards through a dispensing channel with a free-fall section, where they are picked up by a receiving element or a sample container catcher of the analyzer or another sample supply device. The sample container can be transported further into, onto or from such a receiving element, for example by means of a conveyor belt or a simple gripper arm, whereby the correct alignment is already ensured by the sample feeding device according to the invention.

To align the sample containers, the alignment device has, in particular, a reversing device by means of which the orientation of a sample container can be selectively changed. In this context, the orientation of the sample container is to be understood in particular in relation to its longitudinal axis. It is therefore possible, for example, to reverse sample containers that have an incorrect orientation before dispensing and thus bring them into the orientation defined as correct. In particular, this can mean rotating a sample container by 180° so that the sample container has an opposite orientation in relation to its longitudinal axis after reversal. Alternatively or additionally, a further influence on the position of the sample container can also be provided, for example a rotational movement around the longitudinal axis, so that the sample container also has a well-defined orientation in this respect.

In a preferred embodiment, the reversing device has a pin which initially inhibits the movement of a sample container through the alignment device. In particular, when the sample container moves at least substantially in the direction of its longitudinal axis, such a pin-shaped element can be used to either allow the sample container to pass unchanged or to reverse the sample container before or during further movement, depending on the orientation of the incoming sample container.

In particular, the preferred crucible shape of sample containers can be used here, which has an opening on one side that usually points upwards in the correct orientation when it is dispensed or passed on to the analyzer. If such a sample container with the shape of a hollow cylinder, cuboid or the like moves along its longitudinal axis, for example through a feed channel to the alignment device, the front of the sample container can come into contact with the pin of the reversing device.

There are two main cases to be distinguished here. On the one hand, the sample container can arrive with the closed bottom first, so that it would already have the usually correct orientation during the unhindered or uninfluenced further movement. On the other hand, the sample container can have a reversed orientation with respect to its longitudinal direction when it arrives at or in the alignment device. In this case, a reversal of the sample container results in its orientation being changed so that the closed base takes the place of the opening, and vice versa. If the sample container is inverted before or with the release for further movement, it also has the correct orientation with the opening facing upwards when it is dispensed.

The effect of the pin of the reversing device is particularly such that an ideally crucible-or cup-shaped sample container, which arrives at the pin in the wrong orientation, initially moves until the pin engages in the sample receiving space inside. The movement of the sample container ends at the latest when the bottom of the container touches the front of the pin on the inside.

The pin is preferably pivotably mounted so that, on contact with the incoming sample container, it is deflected from a rest position into a release position, in particular by its own weight. If this happens with the closed end of the sample container first when it comes into contact with the sample container, the pin moved into the release position preferably allows the sample container to continue moving unchanged, for example along a movement channel towards a dispensing opening. However, if the sample container first moves with the opening in front to such an extent that the pin of the reversing device comes into engagement with the inside of the sample container, the sample container is forced to first follow a lateral swiveling movement of the pin before moving on. Here, the longitudinal orientation of the sample container is preferably changed at least to such an extent that it is ensured that it has the correct orientation when it is dispensed.

Preferably, the sample container is moved by the sample feed device in the area of the alignment device at least essentially as a result of gravity, i.e. based on the dead weight of the sample container. In this case, the sample container slides, for example, along a feed channel in the direction of the alignment device or the reversing device. According to the invention, it is not necessary for the sample container to move strictly vertically, i.e. in the perpendicular direction. Similarly, a movement at an acute angle to the horizontal plane or even parallel to it can also be provided in particular.

With regard to the direction in which the sample containers are fed to the alignment device, the reversing device is preferably designed in such a way that a pivotably mounted pin in its rest position is aligned at least substantially in the direction of the incoming sample containers, with the longitudinal axis of the pin preferably running at least substantially parallel to the longitudinal axis of the sample container when it arrives at the reversing device or there is an acute angle, preferably of no more than 45°, between the longitudinal axes of the pin and the sample container. This allows the pin to be easily moved into the release position by the weight of the incoming sample container. In particular, the release position is orientated at least essentially downwards, i.e. in the direction of gravity. Sample containers that are already correctly aligned thus ideally move through the alignment device with the closed end first, whereby the reversing device or its pin-shaped element is merely swiveled out of the movement path by the weight of the sample container. In contrast, a sample container arriving in the opposite direction, i.e. with the open end first, initially slides onto the pin, so that the swiveling movement of the pin is not triggered by the frontal contact with the outside of the base of the sample container, but by the inner wall of the sample container resting on the pin. After the joint swiveling movement downwards, the sample container preferably slides off the pin as a result of gravity and continues its movement in the direction of the dispensing device, for example along a free-fall path through a dispensing channel.

In an alternative embodiment, the alignment device can also have a structure in which the sample container is first brought into a horizontal position with its longitudinal axis at least essentially perpendicular to the plumb line direction. From this position, the sample container can then move along a free-fall path perpendicular to its longitudinal orientation. An impact device, for example a crossbar or a plate-shaped and/or wedge-shaped element, which is preferably arranged in the center of the longitudinal extension of the sample container, causes the sample container to receive a rotational impulse transverse to its longitudinal direction when it hits it, so that its longitudinal axis is tilted on the horizontal towards an orientation with a component in the plumb line direction. Due to the one-sided closed shape of a crucible-shaped sample container, it has an asymmetrical mass distribution in relation to its longitudinal axis. As a result, the angular momentum always has such an effect when it hits the impact element that the heavier bottom section of the sample container is orientated at least essentially downwards in the perpendicular direction, so that the sample container has the usually preferred orientation with the opening facing upwards during further movement in the direction of fall. If the sample container aligned in this way then reaches the dispensing device of the sample feeding device, for example by entering a dispensing channel with a dispensing opening at its end, correct alignment is ensured during dispensing.

In the case of a pin of the reversing device that can be moved between a rest position and a release position, the pin is preferably subjected to a restoring force acting in the direction of the rest position. This can be realized by a resilient bearing, a magnetically acting element, such as a permanent magnet and/or an electromagnet, an at least partially elastic design of the reversing device or the pin and/or also by a motor-applied torque. Such a restoring force ensures that after the release of a sample container, the starting position for stopping the forward movement of the next sample container and reversing it as required is always assumed again.

It is particularly preferable for the reversing device to have a weight or counterweight to apply the restoring force. Such a counterweight may be arranged on the side of a pivot bearing or pivot axis opposite the pin. In particular, the weight has a mass that is sufficient to produce a higher torque in the direction of the rest position than the mass of the pin alone applies in the direction of the release position. At the same time, the counterweight is preferably dimensioned such that the torque exerted in the direction of the rest position is lower than the weight that is typically exerted on the opposite side, i.e. in particular on the side of the pin, in the direction of the release position when an incoming sample container comes into contact with the pin, in particular slides onto the pin with its inner area.

To adapt to different types of sample containers, the pin and/or a corresponding counterweight can be adjustable, removable and/or replaceable. In particular, by adjusting the counterweight accordingly, the torque for proper operation can be adapted to the mass of the sample containers used. In a preferred embodiment, the counterweight can be adjusted in relation to the length of the acting lever, for example by means of a screw thread.

To interrupt the sample supply operation as required, the alignment device can have a blocking device for blocking the reversing device and/or for blocking the movement of the sample container through the alignment device. It is understood that such a blocking device can also start upstream of the alignment device in order to stop or slow down the further movement of the sample containers in the direction of the alignment device. In this way, the sample supply device according to the invention not only ensures the correct alignment of the sample containers, but can also clock the supply of the sample containers to an analyzer or the supply rate according to the speed at which individual analyses are carried out.

Preferably, a corresponding dispensing sensor is assigned to the dispensing device, by means of which the successful or completed dispensing of a sample container can be detected. On the one hand, it is thus possible to recognize whether or when a feeding process of a sample container to the analyzer has been completed so that the next sample container can be fed. On the other hand, such a dispensing sensor can also be used to recognize if a fault has occurred on the transport path of the sample container, in particular in the area of the dispensing device, for example if a sample container has tilted in a dispensing channel.

Since the sample supply device according to the invention ensures that the sample containers are always correctly aligned when they are dispensed to an analyzer, correspondingly fewer requirements are placed on the provision of the sample containers in advance, i.e. in terms of replenishment. Accordingly, an operator no longer has to ensure that each individual sample container is already correctly aligned prior to insertion into the sample supply device according to the invention. In a preferred embodiment, the sample supply device according to the invention accordingly has a filling device for simplified filling of the sample supply device with a plurality of sample containers. In particular, this may be a funnel-shaped arrangement of components or a funnel itself, and alternatively or additionally a pouring ramp or a similar filling opening, which allows a plurality of sample containers to be loaded into the sample supply device by simply pouring them in. In particular, this allows a procedure in which a storage bag, in which a large number of sample containers are held in random orientation, can be opened and the contents filled into the sample feed device via the filling device. In addition to the great effort involved in individually aligning and arranging sample containers on a tray or similar, this also eliminates the undesirable aspect of direct contact between the operator and the sample containers. On the one hand, this reduces the risk of contaminating the sample containers and thus falsifying the analysis of the samples that are later placed in the containers. Secondly, graphite sample containers, particularly in the form of graphite crucibles, are used for a variety of applications. Here, the individual handling of the sample containers often leads to undesirable contamination of materials for handling the sample containers or on the hands of operators if they come into contact with the containers. This problem is largely eliminated by simply pouring out a collection container with a number of sample containers.

In a preferred embodiment, the sample feeding device according to the invention has a separating device by means of which individual specimens can be extracted from a plurality of sample containers, which may be present in bulk, and fed individually to the alignment device. This further simplifies the handling of the system and further supports trouble-free operation of the alignment device and thus of the sample feeding device as a whole.

The separating device is preferably designed as a conveyor wheel or has a conveyor wheel. The conveyor wheel can have one or preferably several receptacles for sample containers, by means of which individual sample containers are picked up from the supply and transported further in the direction of the alignment device. The receptacles are preferably dimensioned so that only one sample container at a time enters a receptacle, but there is sufficient play around the sample container so that it can both enter and leave the receptacle without tilting and without the sample containers not being picked up by a receptacle if they are not in a certain orientation.

A corresponding receptacle of the separating device for sample containers can, for example, have an increasing cross-section towards its opening, so that sample containers can easily enter the receptacle regardless of their orientation, in particular in bulk. Alternatively or additionally, a slightly tilted orientation of the receptacle can also be provided, whereby the opening of the receptacle, via which a sample container can enter the receptacle, is offset in particular in the direction of movement of the separating device relative to the deeper area of the receptacle. This supports a more reliable picking up of individual sample containers from a disorganized mass, for example in the form of a heap or a loose bulk.

From the separating device, the separated sample containers preferably reach the aligning device via a feed channel. In particular, the feed channel is dimensioned so that sample containers can only move through it parallel to their longitudinal axis, so that they arrive at the alignment device either bottom first or opening first. This additionally supports the proper operation of the alignment device as described above.

It is understood that the feed channel is generally not limited to a specific length or a specific course. In particular, if movement of the sample containers through the feed channel as a result of their own weight is to be utilized, the alignment of the feed channel can have a component in the perpendicular direction, at least in sections. In addition to a course in a vertical direction or at a certain angle to the horizontal plane, a sequence of different course sections can also be provided. Curved sections are also possible. If, for example, in the case of an alternative design of the alignment device, in particular using an impact element in the manner described above, a horizontal alignment of the sample containers before free fall in the direction of the impact element is to be achieved, the feed channel can have a shape, for example, in which the sample container is first accelerated through an at least essentially vertical drop section, then runs through a curved section until it has reached a horizontal orientation and continues to move in this form until it reaches a feed opening through which it exits the feed channel downwards in the direction of the impact element.

A sensor can be assigned to the feed channel, by means of which the entry, exit and/or presence of a sample container in the feed channel or its movement through the feed channel can be detected. This makes it easy to check the operation with regard to the trouble-free transport of the sample containers through the sample feed device. A critical point here is, for example, the transfer of a separated sample container from the separating device into the feed channel at a corresponding discharge opening or the inlet opening into the feed channel. If a sample container becomes jammed at this point between the wall of the feed channel and the lateral boundary of the separating device holder, the process can come to a standstill or even damage the mechanics. A corresponding sensor can help to recognize such faults at an early stage.

The jamming of a sample container when entering the feed channel can also be avoided by a widened discharge opening and/or a separate, widened discharge section of the feed channel. In this case, a section of the feed channel associated with the discharge opening, i.e. in particular a section of the feed channel facing the separating device, is preferably funnel-shaped and runs from the inlet opening of the feed channel towards, i.e. in particular in the direction of a subsequent alignment device. Particularly preferably, the widened, in particular funnel-shaped, section of the feed channel has an asymmetrical shape, with the side of the widening which is greater than the center ideally being located in the direction of movement of the sample containers moved by the separating device.

The sample feeding device preferably has a control device for controlling the speed of movement of the separating device. In the case of a conveyor wheel, this applies in particular to its rotational speed. Depending on the data from any sensors, the movement of the separating device can therefore be slowed down or stopped completely if a fault such as the jamming of a sample container is imminent. It is understood that corresponding sensors, in particular position, velocity and/or acceleration sensors, can also be provided to detect the speed of movement of the separating device.

Alternatively or additionally, the alignment device, in particular its reversing device, can also be actively controlled and operated by means of a corresponding regulating device and/or control device. Corresponding data from various sensors of the type mentioned above can also be used in this respect.

In a preferred embodiment, a filling level sensor is also provided, which monitors the filling level in the area of the filling device or in a reservoir associated with the filling device. In particular, a plurality of sensors can also be assigned to the filling device, whereby, for example, one sensor monitors the fill level of the sample container reservoir with comparatively coarse accuracy, so that a signal or a message can be output by a corresponding control device when the fill level falls below a certain level and refilling of the sample containers is required. A further sensor can, in particular, determine whether any sample containers are filled at all and, for example, issue a message after the last sample container from the supply has been used up, so that the operation of the sample feeding device or the movement of parts of it, in particular the separating device, is stopped by a corresponding control device.

A sample supply method according to claim 10 is also of particular inventive significance.

According to the method, the sample supply or the supply of sample containers to an analyzer is carried out by first providing a plurality of sample containers. These are preferably basically crucible-shaped sample containers, which in particular have the basic shape of a hollow cylinder and/or cuboid closed at one end.

The sample containers are then separated according to the process, whereby this can be carried out automatically in particular by means of a corresponding separating device.

This is followed by a defined alignment of an individual sample container in an orientation defined by the application situation. The orientation depends in particular on how the sample container is subsequently used with or by an analyzer. It is particularly preferable to provide the sample container in an upright orientation, with the opening facing upwards, so that the sample container can be filled with a sample material from above, in particular by utilizing gravity. The sample container is orientated in particular by selectively reversing its orientation in relation to its longitudinal axis. A distinction is preferably made here as to whether the sample container is already in a fundamentally correct orientation or an initial position suitable for the correct orientation. In particular, a reversal only takes place if this is not the case. Otherwise, further movement of the sample container can be enabled or released without hindrance. The sample container is aligned or reversed in particular by means of a corresponding alignment device, preferably using a corresponding reversing device.

Finally, the sample container is dispensed in the reverse orientation, if necessary, in accordance with the method. Ultimately, the method according to the invention thus ensures that all sample containers dispensed have a suitable orientation for further use with an analyzer, irrespective of their initial position.

It is understood that all the embodiments and application aspects described above in relation to the sample supply device can also be used in a corresponding manner in the sample supply method according to the invention.

In the following, the present invention is explained in more detail with reference to preferred embodiments. All the features described and/or illustrated form independent aspects of the present invention, irrespective of their combination in the embodiments shown or the references in the claims.

It shows

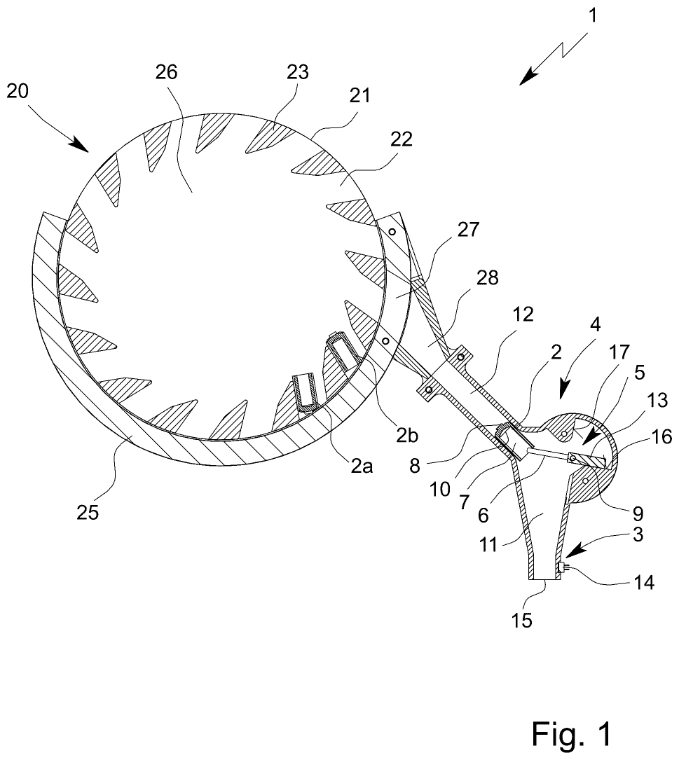

FIG. 1a schematic cross-sectional representation of a preferred embodiment of the sample feeding device according to the invention,

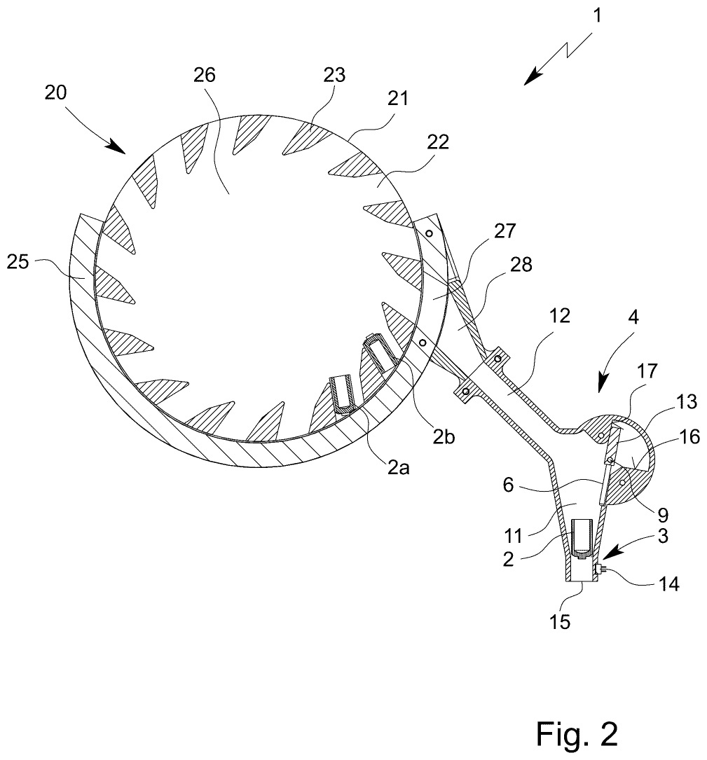

FIG. 2 an illustration of the sample feeding device of FIG. 1 corresponding to FIG. 1 in a further operating state,

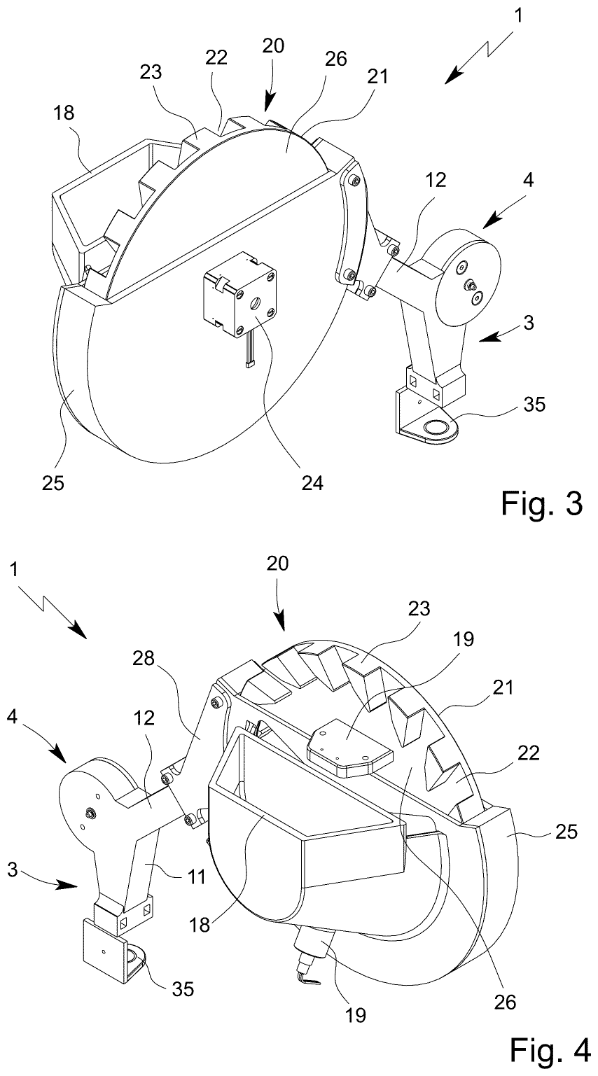

FIG. 3a perspective schematic representation of the sample feeding device of FIG. 1,

FIG. 4 an alternative view of the sample feeding device of FIG. 1 in perspective schematic representation,

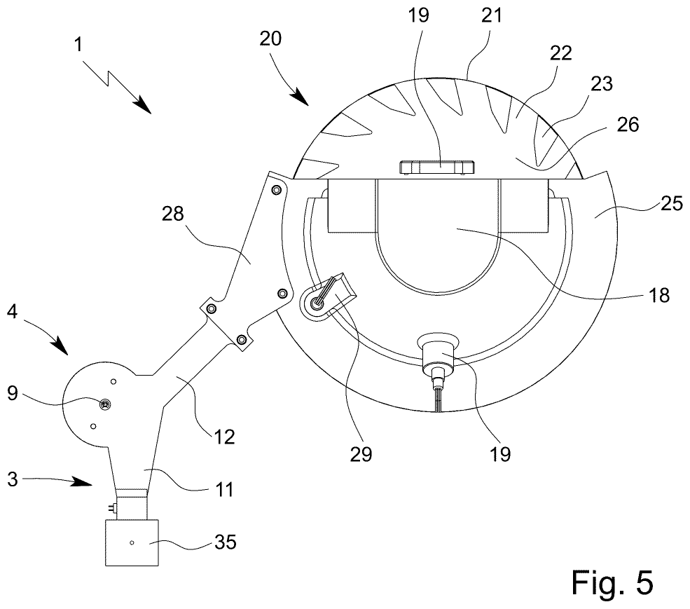

FIG. 5a schematic representation of the sample feeding device of FIG. 1 in side view,

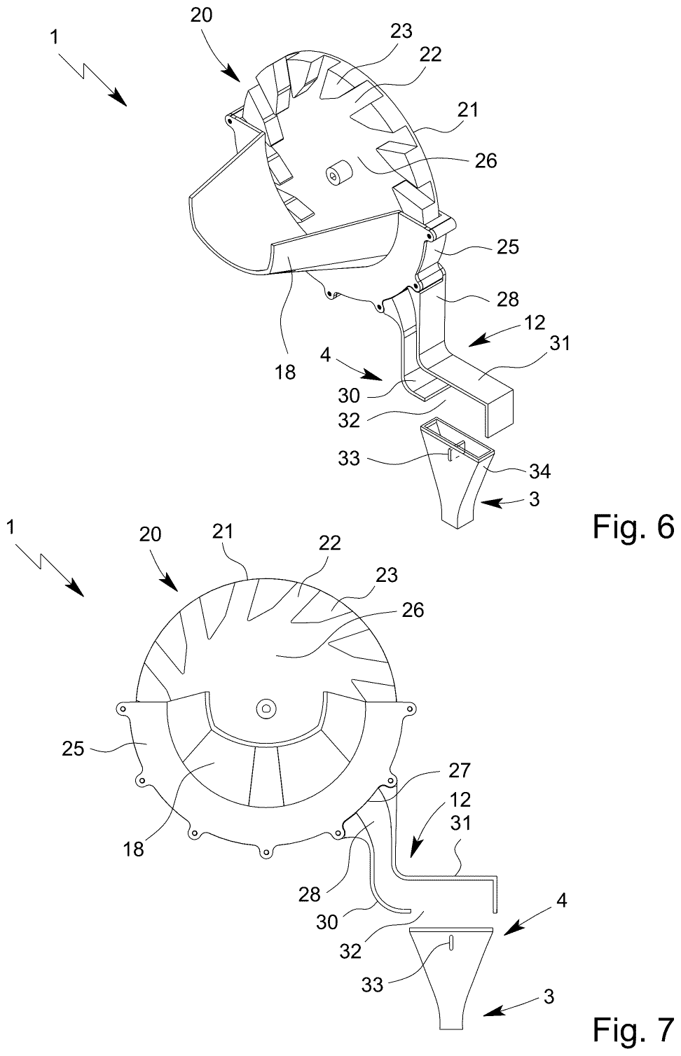

FIG. 6a perspective schematic representation of an alternative embodiment of the sample feeding device according to the invention, and

FIG. 7a schematic representation of the sample feeding device of FIG. 6 in side view.

FIGS. 1 and 2 show a sample feeding device 1 according to the invention in a preferred embodiment. The sample feeding device 1 is used to feed sample containers 2 to an analyzer, which is not shown in detail for the sake of clarity. In general, the sample feeding device 1 according to the invention can preferably also be coupled not only with a specific analyzer, but is suitable for use with different analyzers. Another possibility is to use the sample supply device 1 according to the invention merely as one element of a chain of individual sample supply sections in a laboratory environment.

The sample feeding device 1 according to the invention is characterized by the fact that it dispenses sample containers 2 in a well-defined alignment or orientation by means of a dispensing device 3, so that the sample containers 2 can be further used correctly by the subsequent analysis device without further ado. According to the invention, the sample containers 2 are aligned by an alignment device 4, which is functionally and structurally upstream of the dispensing device 3. In the present case, the upstream arrangement refers in particular to the direction of movement of the sample containers through the various sections or components of the sample feed device 1.

In the embodiment shown, the orientation device 4 has a reversing device 5 by means of which the orientation of the sample container 2 can be selectively changed or reversed with respect to its longitudinal axis. In this context, selective means that the orientation of the sample container 2 is only changed if this is necessary due to its initial position in order to align it correctly for further use with the analyzer by means of the dispensing device 3.

In the preferred embodiment shown in FIGS. 1 and 2, the reversing device 5 has a pivotably mounted pin 6, which can be moved between a rest position as shown in FIG. 1 and a release position as shown in FIG. 2.

The pin 6 does not necessarily have to be cylindrical or have a constant thickness or a constant cross-sectional shape. The term “pin” ultimately includes elongated components of various types. These can be, for example, differently shaped material protrusions or tongues. A mandrel, cone or cone also falls functionally under the term “pin” in the sense of the present invention.

When a sample container 2 arrives at the alignment device 4 as shown in FIG. 1, the pin 6 of the reversing device 5 in the rest position initially prevents further movement of the sample container 2 in the direction of the dispensing device 3. In the present case, the sample container 2 has the preferred shape of a crucible with an interior 7 and a base 8, which closes the sample container 2 at one of its end faces, so that access to the interior 7 is only possible on one side. If the sample container 2 hits the pin 6 of the reversing device 5 with the base 8 in front, the sample container 2 exerts a torque on the reversing device 5 in the direction of its release position due to its own weight. This is possible in particular if there is a certain angle between the longitudinal axis or the direction of movement of the sample container 2 when it arrives at the alignment device 4 and the longitudinal axis of the pin 6 of the reversing device 5, i.e. the two longitudinal axes of the sample container 2 and the pin 6 or the reversing device 5 are not exactly parallel overall. Due to the torque exerted, the reversing device 5 moves in the direction of its release position shown in FIG. 2 by the pin 6 swiveling downwards about a swivel axis 9 and clearing the way for the sample container 2 to continue moving.

However, if a sample container 2 arrives at the alignment device 4 with its open side first, as shown in the illustration according to FIG. 1, the pin 6 comes into engagement with the interior 7 of the sample container 2. The movement of the sample container 2 ends at the latest when the distal end of the pin 6 comes into contact with the bottom inside 10 of the sample container 2. In this state, the sample container 2 is located in particular above a dispensing channel 11 of the dispensing device 3. The sample container 2 has thus preferably left a feed channel 12 through which it was fed to the alignment device 4. In this state, the sample container 2 is preferably held exclusively by the reversing device 5 or the pin 6 of the reversing device 5. If the reversing device 5 now moves in the direction of its release position, the pin 6 moves into a position pointing downwards in the direction of the dispensing device 3. The sample container 2 follows this movement of the reversing device 5 or even causes it by its own weight. As a result, however, its orientation with respect to its longitudinal axis is effectively rotated by 180° compared to its original position, whereby this is to be understood relative to its direction of movement. The actual angle between the orientation when the sample container 2 arrives and when it is dispensed ultimately depends on the individual design. However, the specific shape and dimensions of the various components of the sample feeding device 1 according to the invention can vary in individual cases depending on the respective application situation, for example on the downstream analysis.

As can be seen in the sectional view according to FIGS. 1 and 2, the dispensing device 3 or a corresponding dispensing channel 11 is shaped in particular in such a way that there is sufficient space in the area of the alignment device 4 or the reversing device 5 to allow the reversing device 5 to move together with the sample container 2 without any problems. For this purpose, the output channel 11 can, for example, have a conical cross-sectional shape or be widened accordingly in some other way.

In the exemplary embodiment shown, the reversing device 5 has a counterweight 13 on the side of the swiveling axis 9 facing away from the pin 6, which exerts a torque on the reversing device 5 in the direction of the rest position. In particular, the counterweight 13 can be adjusted, for example by changing the distance to the swiveling axis 9, i.e. by varying the length of the lever arm.

The change in the position of the counterweight 13 relative to the swivel axis 9 can be realized, for example, by the counterweight 13 being fastened by means of a screw thread, on which it is axially displaced by further screwing in or unscrewing. In accordance with the invention, both an internal and an external thread can be provided on the counterweight 13, which interacts with a corresponding mating thread. It is understood that, as an alternative to a thread, a pure displacement of the counterweight 13 on a support arm of the reversing device 5 is also possible. The counterweight 13 is preferably secured against a change in position with respect to the swiveling axis 9, whereby this takes place in particular according to a force-fit or friction-fit and/or a form-fit principle.

Alternatively or additionally, the counterweight 13 can also be removable or replaceable.

By changing or replacing the counterweight 13, the torque acting in the direction of the rest position of the reversing device 5, i.e. the restoring force, can be adjusted. In this way, the reversing device 5 can be adjusted for operation with sample containers 2 of different masses. The ideal result is that, in the state of the reversing device 5 without contact with a sample container 2, the torque acting in the direction of the rest position predominates, so that the reversing device 5 is guaranteed to return automatically to the rest position. If the reverse device 5 is now subjected to the weight of a sample container 2 at its end opposite the counterweight 13 with respect to the swiveling axis 9, i.e. in particular at a pin 6 or pin-shaped element, the torque acting in the direction of the release position predominates, so that a movement of the reverse device 5 is triggered.

Alternatively or in addition to a counterweight 13, a restoring force can also be achieved by a spring device, a magnetically or electromagnetically acting component and/or a general design of the reversing device 5, in particular the pin 6, made of a flexible or elastic material. A combination of different means is also possible in this context.

A further alternative, which can also be realized in addition to the other described configurations of the reversing device 5, is an active, in particular motor-driven, movement of the reversing device 5 into the release position and/or into the rest position. This makes it possible to control and influence the sequence or operation of the alignment device 4 and thus ultimately of the sample feeding device 1 as a whole to a particular degree.

A blocking device, which is not shown in detail, can be used to prevent the movement of the reversing device 5 and/or to fix the reversing device 5 in a certain position, in particular the rest position and/or the release position. Alternatively or additionally, a corresponding blocking device can also be provided to block the movement of a sample container 2 through the feed channel 12, the alignment device 4 and/or the dispensing device 3.

In the context of the present invention, a corresponding blocking device can act in particular in a form-fit manner by introducing a blocking member into the movement path of the sample container 2 or the reversing device 5. Alternatively or additionally, the blocking effect can also be achieved according to a force-locking principle, for example by increasing the friction on the swiveling axis 9 and/or clamping the sample container 2, for example by reducing the cross-section of the feed channel 12 by means of clamping jaws or comparable components.

The sample feeding device 1 according to the invention can also have one or more sensors. In the preferred embodiment shown in FIGS. 1 and 2, for example, a dispensing sensor 14 is provided, which is assigned to the dispensing device 3 and is arranged at the end of the dispensing channel 11, i.e. in the vicinity of a dispensing opening 15. The successful dispensing of a sample container 2 can be verified by means of the dispensing sensor 14. It can then be assumed that a new sample container 2 can pass through the alignment device 4 and the dispensing device 3 undisturbed.

The data obtained by means of a corresponding sensor can be used by a monitoring, control and/or regulating device to output messages, in particular warning messages, to an operator via a corresponding user interface if a fault is detected in the process. In addition, it is possible to carry out a statistical survey of the operation, for example in relation to the absolute and/or per time unit dispensed number of sample containers 2. Preferably, alternatively or additionally, the operation of the sample feeding device 1 as such, in particular the alignment device 4, can also be regulated depending on the sensor data recorded, for example by activating or deactivating corresponding blocking devices.

In the exemplary embodiment shown, the swiveling reversing device 5 has a swivel range of approximately 90°. In the rest position, the counterweight 13 rests against a rest stop 16. In the direction of the release position, the movement of the reversing device 5 is limited by a release stop 17. If the sample container 2 detaches from the reversing device 5 before reaching the release stop 17 (in the case of reversing the sample container 2) or has already moved past the reversing device 5 in the direction of the dispensing device 3 (in the case of an incoming sample container 2 with the correct orientation), the reversing device 5 will move back towards the rest position from this point onwards. The release position is therefore to be understood functionally and is not strictly defined by reaching the maximum deflection of the reversing device 5 or reaching the release stop 17. The same applies to the rest position if a new sample container 2 reaches the reversing device 5 before it reaches the rest stop 16.

In the perspective view of FIGS. 3 and 4 and in the side view according to FIG. 5, it can be seen that the sample feeding device 1 according to the invention in the exemplary embodiment shown has a filling device 18, in particular in the form of a funnel or a pouring ramp or a combination of the aforementioned. The filling device 18 is preferably designed in such a way that a receiving volume for a sample container reservoir is created in the inner area delimited by it. Alternatively or additionally, a separate reservoir can also be provided, which is filled via the filling device 18. A plurality of sample containers 2 can thus already be stored in the sample supply device 1, so that a continuous supply to a downstream analysis can be maintained over a comparatively long period of time by sequential dispensing of the sample containers 2. In particular, the filling device 18 is sufficiently dimensioned to hold at least ten, preferably at least 25, particularly preferably at least 50, sample containers 2 in stock.

The quantity of sample containers 2 in the reservoir can, for example, be detected using a fill level sensor 19. Preferably, a plurality of fill level sensors 19 can also be used.

The sensors used in the context of the present invention can in principle operate in different ways or function according to different operating principles. In particular, designs based on the principle of a light barrier are suitable for detecting the passage or presence of a sample container 2 at a specific point. An exemplary application for a light barrier sensor is the dispensing sensor 14. Other sensors that can detect the presence of one or more sample containers 2, for example, work according to an induction principle and/or by means of LIDAR. One example of this is fill level sensors 19. It should be understood, however, that ultimately each of the sensors mentioned can work according to each of the exemplary principles mentioned and that combinations, for example inductive measurement supported by LIDAR using a further sensor, are also possible.

In the embodiment shown, a separating device 20 is used to feed sample containers 2 from the reservoir in the area of the filling device 18 individually to the alignment device 4, so that on the one hand this can work without interference and on the other hand a sequential output of individual sample containers 2 and their feed to the analysis can take place. In the present example, the separating device 20 is designed as a conveyor wheel 21 or has one. Alternatively, a design as a conveyor belt, conveyor chain or the like is also possible.

The conveyor wheel 21 is designed in particular in the manner of a paddle wheel and preferably has a plurality of receptacles 22 for the sample containers 2, the receptacles 22 being separated from each other by paddle elements 23 and defined in their shape.

The conveyor wheel 21 is set in rotation by a motor and is arranged in particular relative to the filling device 18 in such a way that the receptacles 22 are moved through below the sample containers 2 in the filling device 18 or in the sample container reservoir. The outer area of the conveyor wheel 21 with the paddle elements 23 and the receptacles 22 defined thereby extends in particular through a housing part 25, the width of which corresponds approximately to the height of the paddle elements 23, with which they project from a base plate 26 of the conveyor wheel 21 and thus define the width of the receptacles. In the area of the housing part 25, the receptacles 22 are accordingly limited by the blade elements 23, the base plate 26 of the conveyor wheel 21 and by the walls of the housing part 25 and are only accessible through an opening pointing at least substantially radially inwards.

Due to a corresponding arrangement of the filling device 18 on the housing part 25, the transition between the filling device 18 and the housing part 25 runs in particular in the area of the accessible opening of the receptacles 22 and/or just above it, i.e. radially offset inwards. Due to a corresponding inclination and/or shape of the filling device 18, for example as a pouring ramp, which can also be provided only in sections, sample containers 2, in particular in the form of a loose fill, now rest against the base plate 26 of the conveyor wheel 21 and, as a result of the effect of gravity, at least some of them get into the receptacles 22. This can be supported by a correspondingly asymmetrical shape and/or an orientation of the receptacles 22 inclined with respect to the radial direction in conjunction with the rotation of the conveyor wheel 21. The inclination of the receptacles 22 is predetermined by the shape of the blade elements 23 and is preferably designed in such a way that the opening of the receptacles 22 is offset relative to the radial direction in the direction of rotation of the conveyor wheel 21.

If a sample container 2 is placed in a receptacle 22, in particular from a loose fill, its orientation can ultimately assume only two states in the illustrated embodiment of the sample feeding device 1. Either its base 8 points radially outwards, as shown for the sample container 2a in FIGS. 1 and 2, or the base 8 points radially inwards, so that the opening of the interior 7 of the sample container 2 points radially outwards, as in the case of the further sample container 2b also shown in FIGS. 1 and 2.

In the present case, the separating device 20 is connected to the alignment device 4 by means of the feed channel 12. The separated sample containers 2 can leave the receptacles 22 of the conveyor wheel 21 radially outwards through a corresponding discharge opening 27 and from there enter the feed channel 12, initially retaining their orientation. When they reach the alignment device 4 with the reversing device 5 through the feed channel 12, their orientation may be reversed in the manner described above so that, as a result, all sample containers 2 have the same orientation when they reach the dispensing device 3.

The feed channel 12 can have a discharge section at its end facing the discharge opening 27, i.e. the separating device 20, which has a widened cross-section in the direction of the discharge opening 27. Here, as shown in FIGS. 1 and 2, an asymmetrical structure with a greater widening in the direction of rotation of the conveyor wheel 21 is preferred. This reduces the risk of a sample container 2 becoming jammed when it emerges from the holder through the discharge opening 27 into the discharge section or the feed channel 12.

In principle, the speed of movement of the separating device 20, in particular the rotational speed of the conveyor wheel 21, should be sensibly calculated according to the dimensions of the sample containers 2 and according to how quickly they can slide out of the receptacle 22 due to their surface properties in interaction with the surfaces delimiting the receptacle 22. Alternatively or additionally, the position of the discharge opening 27 in the direction of rotation should also be taken into account, since the influence of the vertically acting gravity on the acceleration of the sample containers 2 is measured according to this.

The further in the lower area of the conveyor wheel 21 the discharge opening 27 is positioned, i.e. the steeper the sample container 2 is when leaving the receptacle 22, the more it is accelerated when leaving the receptacle. While the sample container 2 is still partially located both in the receptacle 22 and already in the feed channel 12 or its discharge section 28 as it exits the receptacle 22, care must therefore be taken to ensure that the separating device 20 does not move so far that the receptacle 22 is moved too far past the discharge opening 27, so that the sample container 2 is jammed and interferes with the movement of the separating device 22 and thus with the operation of the entire sample feeding device 1.

To avoid the aforementioned problems, the speed of movement of the separating device 20 can be monitored and regulated by means of a control device. Appropriate sensors can be provided for this purpose. In particular, an ejection sensor 29 associated with the separating device 20 can be arranged in particular in the region of the ejection opening 27 and can detect the presence of a sample container 2 in a receptacle 22 shortly before or directly at the ejection opening 27.

Such an ejection sensor 29 can also detect when the sample container 2 has completely left the receptacle 22. If the sample container 2 has not yet left the receptacle 22 when the progressive movement of the separating device 20 has reached a certain point at which there is now a risk of the sample container 2 becoming jammed in the above-mentioned manner, the speed of movement of the separating device 20 can be reduced or stopped completely by means of a control device until the sample container 2 has completely left the receptacle 22.

It is understood that, in order to monitor the speed of rotation of the conveyor wheel 21 or the speed of movement of the separating device 20, one or more corresponding sensors can generally be provided which can measure the speed of movement directly and/or the distance travelled or the angle of rotation travelled.

FIGS. 6 and 7 also show an alternative embodiment of the sample feeding device 1 according to the invention. Here, a filling device 18 and a separating device 20 are also provided in the manner described above.

However, the alignment device 4 is designed in such a way that it essentially requires no moving parts.

The feed channel 12, which guides the sample containers 2 from the separating device 20 to the aligning device 4 after separation, is shaped in the present example in such a way that a sample container 2 first travels an at least substantially vertical section on which it is accelerated as a result of gravity. This is followed by a curved section 30, which deflects the sample container 2 and brings it into a horizontal orientation that is preferably at least substantially perpendicular to the direction of the plumb line. In this position, the sample container 2 still moves a certain distance along a horizontal section 31 of the feed channel 12 as a result of its inertia until a release opening 32 is reached.

The sample container 2 now exits the release opening 32 in a horizontal downward orientation and reaches the alignment device, which has a reversing device 5 in the form of an impact element 33, by means of a free fall. The impact element 33 is designed as a rod running transversely to the longitudinal axis of the incoming sample container 2. In particular, the impact element 33 is arranged relative to the release opening 32 in such a way that the sample container 2 strikes the impact element 33 approximately with its center, relative to its longitudinal extent. Due to the one-sided arrangement of the base 8, the sample container 2 preferably has an asymmetrical mass distribution, so that it receives an angular momentum when it strikes the impact element 33, which always brings it into an upright orientation such that the base 8 points downwards. In this orientation, which is basically suitable for further use with an analysis in most cases, the sample container 2 falls further into a collecting funnel 34, whose tapered shape corrects any excessive rotation of the sample container 2 and finally flows into the dispensing device 3, by means of which the sample containers 2 are finally dispensed.

Regardless of the design of the sample feeding device 1, in particular the alignment device 4, a catching device 35 can be installed downstream of the dispensing device 3, which picks up the dispensed sample container 2 in the correct orientation. By means of the catching device 35 or starting from it, the final further transport to the analysis can then follow.

List of reference symbols:

| | |
|---|---|
| 1 | Sample feeding device |
| 2 | Sample container |
| 2a | Sample container |
| 2b | Sample container |
| 3 | Dispensing device |
| 4 | Alignment device |
| 5 | Reversing device |
| 6 | Pen |
| 7 | Interior |
| 8 | Floor |
| 9 | Swiveling axis |
| 10 | Bottom inside |
| 11 | Output channel |
| 12 | Cable duct |
| 13 | Counterweight |
| 14 | Dispensing sensor |
| 15 | Dispensing opening |
| 16 | Rest stop |
| 17 | Release stop |
| 18 | Filling device |
| 19 | Level sensor |
| 20 | Separating device |
| 21 | Conveyor wheel |
| 22 | Receptacle |
| 23 | Paddle element |
| 24 | Motor |
| 25 | Housing part |
| 26 | Base plate |
| 27 | Discharge opening |
| 28 | Drop section |
| 29 | Drop sensor |
| 30 | Curve section |
| 31 | horizontal section |
| 32 | Release opening |
| 33 | Impact element |
| 34 | Collection funnel |
| 35 | Catching device |

What is claimed is:

1. A sample supply device for supplying sample containers to an analyzer, comprising:
an alignment device for aligning a sample container in a predetermined orientation; and
a dispensing device for dispensing the sample container, wherein the dispensing device is preceded by the alignment device.

2. The sample supply device according to claim 1, wherein the alignment device has a reversing device for selectively changing the orientation of the sample container with respect to its longitudinal axis.

3. The sample supply device according to claim 2, wherein the reversing device has a pin, wherein at least one of the reversing device and the pin can be moved between a rest position and a release position.

4. The sample supply device according to claim 3, wherein the reversing device is subjected to a restoring force acting in the direction of the rest position.

5. The sample supply device according to claim 2, further comprising a blocking device for accomplishing at least one of blocking the reversing device and blocking the movement of the sample container.

6. The sample supply device according to claim 1, further comprising a dispensing sensor associated with the dispensing device for detecting the dispensing of the sample container.

7. The sample supply device according to claim 1, further comprising a filling device for filling the sample support device with a plurality of sample containers.

8. The sample supply device according to claim 1, further comprising a separating device for separating the sample containers.

9. The sample supply device according to claim 8, further comprising a regulating device for regulating a speed of movement of the separating device.

10. A sample supply method for supplying sample containers to an analyzer, comprising:
provision of a plurality of sample containers;
separation of the sample containers;
aligning a single sample container in a predetermined orientation, wherein the sample container is selectively inverted depending on its orientation with respect to its longitudinal axis; and
dispensing the sample container.

11. The sample supply device according to claim 1, wherein the sample containers have a crucible-shape.

12. The sample supply device according to claim 10, wherein the sample containers have a crucible-shape.

13. The sample supply device according to claim 3, wherein the pin is pivotably mounted.

14. The sample supply device according to claim 4, wherein the reversing device has a counterweight for applying the restoring force, and wherein the counterweight is one or more of adjustable, removable, and replaceable.

15. The sample supply device according to claim 7, wherein the filling device further comprises at least one of a funnel and a pouring ramp.

16. The sample supply device according to claim 7, further comprising a filling level sensor associated with the filling device.

17. The sample supply device according to claim 8, wherein the separating device further comprises a conveyor wheel.

18. The sample supply device according to claim 17, wherein the conveyor wheel further comprises a receptacle for sample containers.

19. The sample supply device according to claim 9, wherein the regulating device is configured to regulate a speed of the conveyor wheel.
